(19) United States
(12) Patent Application Publication
(10) Pub. No.: US 2018/0126697 A1
(43) Pub. Date: May 10, 2018

(54) Multi-Layered Sheets Comprising a High Melt Strength Polypropylene

(71) Applicant: EXXONMOBIL CHEMICAL PATENTS INC., Baytown, TX (US)

(72) Inventor: Anthony Poloso, Marriottsville, MD (US)

(21) Appl. No.: 15/574,876

(22) PCT Filed: Jun. 15, 2016
(86) PCT No.: PCT/US2016/037546

§ 371 Date: Nov. 17, 2017

Related U.S. Application Data
(60) Provisional application No. 62/204,869, filed on Aug. 13, 2015.

(51) Int. Cl. B32B 7/02; B32B 27/08; B32B 27/32

(52) U.S. Cl. CPC B32B 7/02; B32B 2307/30; B32B 27/32; B32B 27/08

(57) ABSTRACT

A multi-layered sheet or profile comprising at least one layer of a high melt strength polypropylene and one layer of another polyolefin, the high melt strength polypropylene comprising at least 50 mol % propylene, and having a molecular weight distribution (Mw_{DRI}/Mn_{DRI}) greater than 6, a branching index (g′) of at least 0.97, and a melt strength greater than 20 cN determined using an extensional rheometer at 190° C. The sheets can be incorporated into thermoformed articles such as pallets, blow molded into hollow containers and drums, and the high melt strength polypropylene can be a layer making up a profile such articles as pipes, all of which are further described herein.

### CROSS-REFERENCE TO RELATED APPLICATION

The present application claims priority to U.S.S.N. 62/204,869, filed Aug. 13, 2015, herein incorporated by reference.

### FIELD OF THE INVENTION

The present disclosure relates to high melt strength polypropylenes for use in sheets and extruded profiles and in particular, for thermoformed articles.

### BACKGROUND OF THE INVENTION

High molecular weight high density polyethylene (HDPE) having a high load melt index, or I₂₁, (ASTM D1238 21.6 kg/190° C. of less than 20 g/10 min) is commonly used for pallets, drums and other durable goods due to its excellent processability and impact strength. However, it is desirable to have higher stiffness without sacrificing these other attributes so that thinner parts and parts that can withstand higher loads can be made. By producing multi-layered structures of HDPE and high melt strength polypropylene (HMS PP) the inventor has found that one can significantly improve part stiffness while maintaining good processing characteristics and physical properties.

Relevant publications include WO 2014/187686; US 2015/0018463; US 2015/0004394; US 2014/070385; US 2014/070384; US 2014/0308502; US 2009/182105; US 2012/295994; US 2015/133590; US 2015/284521; EP 2 492 293 A1; CN 101812165; U.S. Pat. No. 5,731,362; U.S. Pat. No. 6,875,484; U.S. Pat. No. 8,343,613; U.S. Pat. No. 8,709,561; U.S. Pat. No. 8,871,824; U.S. Pat. No. 8,895,685, U.S. Pat. No. 9,200,095 and U.S. Pat. No. 9,068,030.

### SUMMARY OF THE INVENTION

Disclosed herein is a multi-layered sheet or profile comprising at least one layer of a high melt strength polypropylene and one layer of another polyolefin, the high melt strength polypropylene comprising at least 50 mol % propylene, and having a molecular weight distribution (Mw_{DRI}/Mn_{DRI}) greater than 6, a branching index (g′) of at least 0.97, and a melt strength greater than 20 cN determined using an extensional rheometer at 190° C. The sheets can be incorporated into thermoformed articles such as pallets, blow molded into hollow containers and drums, and the high melt strength polypropylene can be a profile extruded into such articles as pipes, all of which are further described herein.

### DETAILED DESCRIPTION OF THE INVENTION

The present invention(s) includes the use of at least one layer of a HMS PP and another polyolefin to form a sheet or profile, where the polyolefin is preferably at least one layer of a polyethylene, especially HDPE. The sheets are useful for any number of articles requiring durability and impact strength and high stiffness. Multi-layered sheets for forming articles can be made using two, three, four, five or more layers of HDPE and a HMS PP. Such multi-layered structures offer superior compression strength and sag resistance compared to the same structure made using 100% HDPE and approach the stiffness of structures made using 100% HMS PP while maintaining the processability and moldability of HDPE alone.

As used herein, a “sheet” is material that has an average thickness of greater than 1.0, or 1.1, or 1.2, or 1.5, or 2.0 mm and may include one or more substances such as polymers, fillers, oils, etc., and preferably is continuous within its measurable width and length, and most preferably has an average thickness within a range from greater than 1.0, or 1.1, or 1.2, or 1.5, or 2.0 mm to 5 or 10 or 20, or 50, or 100 mm The “sheets” described herein can include any number of layers, any layer of which may have the average thickness of a sheet or film. As used herein a “film” is a material that has an average thickness of less than or equal to 1.0 mm and may include one or more substances such as polymers, antioxidants, fillers, tackifiers, etc., and preferably is continuous within its measurable width and length, and most preferably has an average thickness within a range from 2 or 10 or 20 pm to 50 or 100 or 200 or 250, or 1000 μm.

A “profile” is a multi-layered structure that forms a continuous tube of any cross-sectional shape such that articles can then be molded therefrom such as a pipe; profile extrusion can include solid forms (e.g., to make siding for structures) as well as hollow forms (e.g., to make pipes or window frames), the walls of which have an average thickness of greater than 1.0 mm, or as otherwise stated for sheets.

Also, as used herein, “multi-layered” refers to structures including two or more polymers each forming a flat surface having an average thickness, the same or different, that have been combined together and caused to adhere to one another such as by application of radiation, heat, or use of adhesives to form a single multi-layer structure; preferably formed by a process of coextrusion utilizing two or more extruders to melt and deliver a steady volumetric throughput of different viscous polymers, one of which is the high melt strength polypropylene, to a single extrusion head (die) which will extrude the materials in the desired form.

Thus, disclosed herein in any embodiment is a multi-layered sheet or profile, preferably a sheet or profile, comprising at least one layer of a high melt strength polypropylene and one layer of another polyolefin, the high melt strength polypropylene comprising at least 50 mol % propylene, and having a molecular weight distribution (Mw_{DRI}/Mn_{DRI}) greater than 6, a branching index (g′) of at least 0.97, and a melt strength greater than 20 cN determined using an extensional rheometer at 190° C. The sheets can be incorporated into thermoformed articles such as pallets, blow molded into hollow containers and drums, and the high melt strength polypropylene can be profile extruded into such articles as pipes, all of which are further described herein.

The “polyolefin” can be any polymer comprising ethylene or a-olefin derived C3 to C12 monomer units such as isotactic polypropylene, atactic polypropylene, ethylene-propylene copolymer, poly(propylene-co-ethylene/propylene) impact copolymer, polyethylene such as low density polyethylene, linear low density polyethylene, high density polyethylene, plastomers, and mixtures thereof. In any embodiment, the polyolefin is a polyethylene. Most preferably, the polyethylene is a high density polyethylene having a density of at least 0.920, or 0.930 g/cm³, or within a range from 0.920 or 0.930 g/cm³ to 0.950 or 0.960 cm³; and has a I₂₁ of less than 20 or 10 g/10 min; or within a range from 2.0 or 4.0 or 6.0 g/10 min to 15 or 20 g/10 min. A most preferred structure includes sheets comprising (or consisting essentially of, or consisting of) at least one layer of high melt strength polypropylene and at least one layer of high density polyethylene.

The multi-layered layers of sheets, or layers making up the extruded profile, can take on any number of structures such as HMS PP/HDPE, HMS PP/HDPE/HMS PP, HDPE/HMS PP/HDPE, HDPE/HMW PP/HDPE/HMS PP, HMS PP/HDPE/HDPE/HMS PP, HMW PP/LLDPE, HMS PP/LLDPE/HMS/PP, LLDPE/HMS PP, LLDPE/HDPE/HMS PP, LLDPE/HDPE/HMS PP/HDPE, LLDPE/HDPE/HMS PP/HDPE/LLDPE, wherein “HMS PP” is the high melt strength polypropylene as described herein.

### High Melt Strength Polypropylenes

The inventive sheets comprise (or consist of, or consist essentially of) a polypropylene having a relatively high Melt Strength (greater than 20 cN), referred herein simply as a “high melt strength polypropylene” (or HMS PP) having certain desirable features as first described in WO 2014/070386. In particular, in any embodiment the high melt strength polypropylene useful herein comprises at least 50, or 60, or 70, or 80, or 90 mol % propylene-derived monomer units, or within a range from 50, or 60, or 80 to 95, or 99 mol % propylene-derived units, the remainder of the monomer units selected from the group consisting of ethylene and C₄ to C₂₀ α-olefins, preferably ethylene or 1-butene. In any embodiment the high melt strength polypropylene is a homopolymer of propylene-derived monomer units.

In any embodiment, the high melt strength polypropylene has an isopentad percentage of greater than 90, or 92, or 95%. Also in any embodiment the high melt strength polypropylene has a melt flow rate (MFR) within the range from 0.1 or 1 or 2 g/10 min to 12 or 16 or 20 or 40 g/10 min, determined according to ASTM D1238 Condition L (230° C./2.16 kg).

In any embodiment, the high melt strength polypropylene has a molecular weight distribution (Mw_{DRI}/Mn_{DRI}) greater than 6 or 7 or 8; or within a range from 6 or 7 or 8 to 14 or 16 or 18 or 20. Also in any embodiment the high melt strength polypropylene has an Mz_{DRI}/Mw_{DRI} value of less than or equal to 3.6 or 3.4 or 3.2 or 3.0. The high melt strength polypropylenes useful herein tend to be highly linear as evidenced by a high branching index. Thus, in any embodiment the high melt strength polypropylenes have a branching index (g′, also referred to in the literature as g′_{vis avg}) of at least 0.97 or 0.98, as determined in column 37 of U.S. Pat. No. 7,807,769 determined by using a High Temperature Size Exclusion Chromatograph (either from Waters Corporation or Polymer Laboratories), equipped with three in-line detectors, a differential refractive index detector (DRI), a light scattering (LS) detector, and a viscometer. In any embodiment, the high melt strength polypropylenes useful herein have a melt strength greater than 10 or 18 or 20 cN determined using an extensional rheometer at 190° C.; or within a range from 10 or 18 or 20 cN to 35 or 40 or 60 or 80 or 100 cN.

In any embodiment, the high melt strength polypropylenes have a viscosity ratio within the range from 35 to 80 determined from the complex viscosity ratio at 0.01 to 100 rad/s angular frequency at a fixed strain of 10% at 190° C. Also in any embodiment the high melt strength polypropylene has a Peak Extensional Viscosity (annealed) within a range from 10, or 20 kPa·s to 40 or 50 or 55 or 60 or 80 or 100 kPa·s at a strain rate of 0.01 /sec (190° C.).

In any embodiment, the high melt strength polypropylene has a heat distortion temperature of greater than or equal to 100° C., determined according to ASTM D648 using a load of 0.45 MPa (66 psi). Finally, in any embodiment the high melt strength polypropylene has a Modulus within the range from 1800 or 2000 MPa to 2400 or 2500 MPa determined according to ASTM D790A on nucleated samples with 0.1% α-nucleating agent.

In any embodiment, the high melt strength polypropylenes used to make multi-layered sheets, profiles or articles made from such sheets and profiles is a reactor-grade material, meaning that it is used as it comes out of the reactor used to produce it, optionally having been further made into pellets of material that has not altered any of its properties such as the branching index, MWD, melt flow rate, etc., by more than 1% of its original value. In any embodiment, the HMS PP has not been cross-linked or reacted with any radiation or chemical substance such as a butadiene, 1,3-hexadiene, isoprene or other diene-containing compound, allyl compound, or bifunctionally unsaturated monomer(s) to cause cross-linking and/or long-chain branching, such as disclosed in, for example, U.S. Pat. No. 8,895,685. Typical forms of radiation known to cause cross-linking and/or long-chain branching include use of electron-beams or other radiation (beta- or gamma-rays) that interact with the polymer. But also in any embodiment, the high melt strength polypropylene is further treated to form a hyperbranched polypropylene as described herein, and such hyperbranched polypropylene can be used in sheets, profiles and other articles as described for the HMS PP.

### Hyperbranched Polypropylene

In any embodiment, the multi-layered sheets comprise at least one layer of a hyperbranched polypropylene. The hyperbranched polypropylene is preferably formed by melt blending the high melt strength polypropylene with from 0.01 wt % to 3 wt % of at least one organic peroxide, by weight of the high melt strength polypropylene. The “organic peroxide” is any organic compound comprising at least one —(O)COO— group and/or O—O— group, and having a half-life of less than one hour or 30 minutes at 100° C., preferably a half-life within the range from 0.10, or 0.5, or 1, or 5, or 10 seconds to 5 minutes, or 10 minutes, or 30 minutes, or 60 minutes at 100° C. It is also preferable if the peroxide melts before it reacts with the high melt strength polypropylene so that the granules get evenly coated and the high specific surface area is utilized prior to the branching and/or cross-linking reactions. In any embodiment, reactor granules of the high melt strength polypropylene used herein are preferred over extruded pellets. Such high melt strength polypropylene granules are preferably blended with the organic peroxide before melt extrusion.

In any embodiment, the organic peroxide is selected from compounds having one or more structures selected from:

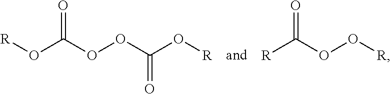

wherein each “R” group is independently selected from the group consisting of hydrogen, C1 or C5 to C24 or C30 linear alkyls, C1 or C5 to C24 or C30 secondary alkyls, C1 or C5 to C24 or C30 tertiary alkyls, C7 to C34 alkylaryls, C7 to C34 arylalkyls, and substituted versions thereof. By “substituted” what is meant are hydrocarbon “R” groups having substituents such as halogens, carboxylates, hydroxyl groups, amines, mercaptans, and phosphorous containing groups. In a particular embodiment, each “R” group is independently selected from C8 to C20 or C24 linear, secondary, or tertiary alkyls, such as octyl, decyl, lauryl, myristyl, cetyl, arachidyl, behenyl, erucyl and ceryl groups and linear, secondary or tertiary versions thereof.

In any embodiment, the level of peroxide can be adjusted such that the optimal or peak value of I₂₁/I₂ (I₂ is the “melt index”, ASTM D1238 2.16 kg/190° C.) is when the amount of organic peroxide added when forming the compositions is within a range from 1.0, or 1.1 wt % to 1.5, or 1.6, or 1.8 wt %. Thus, in any embodiment of the reaction product and/or method of forming the hyperbranched polypropylenes, a preferred level of organic peroxide is within a range from 1.0, or 1.1 wt % to 1.8, or 2.0, or 2.2 wt % by weight of the composition.

The formation of the hyperbranched polypropylenes described herein are effected in any embodiment by melt blending or melt extrusion, especially through shear forces and applied radiative heating during blending/extrusion, to a melt temperature of at least the melting point of the high melt strength polypropylene, such as at least 140, or 150, or 160, or 180° C., or within a range from 150, or 160° C. to 180, or 200, or 220, or 240, or 260, or 280, or 300° C.

In any embodiment, a crosslinking agent may be present with the peroxide to effect formation of the hyperbranched polypropylene. The crosslinking agents are selected from the group consisting of divinyl benzenes, tri(alkyl allyl) cyanurates, and tri(alkyl allyl) isocyanurates, and may be present to within a range from 0.01 to 5 wt % by weight of the polymer, peroxide and other additives. Preferably, such crosslinking agents are absent.

In any embodiment the hyperbranched polypropylenes, directly from the extrusion process, are formed into reactor flakes and/or granules, or extruded pellets without being treated under vacuum and/or solvent washing.

Thus formed, the hyperbranched polypropylenes described herein is ready to ship, transport, and/or store without further treatment, and be used in making any number of articles, both foamed and non-foamed (as described further below). In any embodiment a foaming agent may be added during the heating/extrusion process described above such that the agent is not activated until after shipping and ready to form into a foamed article. As mentioned, the composition may be later heated/extruded again to form articles and effect foaming, if so desired. In any embodiment however, the hyperbranched polypropylenes may be heated up to below its melting point temperature prior to combining with the organic peroxide, for instance, to a temperature within a range from 100, or 110, or 120° C. up to the melting point temperature such as 150, or 155, or 160° C.

In any embodiment, other “additives” may also be present in the sheets or profiles of high melt strength polypropylenes or hyperbranched polypropylenes as is known in the art, in any embodiment up to 1, or 2, or 3 wt % by weight of the compositions. These additives may be added before, during, or after the formation of the multi-layered sheets. Such additives include antioxidants (e.g., hindered phenol- and phosphite-type compounds), stabilizers such as lactone and vitamin E, nucleators, colorants (dyes, pigments, etc.), fillers (silica, talc, etc.), UV stabilizers, release agents, tackifiers, anti-static agents, acid scavengers (e.g., calcium stearate), anti-blocking agents, anti-blooming agents, and other common additives as is known in the art. In a preferred embodiment, even when the high melt strength polypropylene or hyperbranched polypropylene sheets “consist of” the named components, the composition may nonetheless include up to 4000 ppm of one or more antioxidants, or up to 4000 ppm of each of antioxidants (one or more) and foaming agents (one or more).

The high melt strength polypropylenes or the hyperbranched polypropylenes may further comprise a foaming agent as is known in the art to effect the formation of air containing pockets or cells within the composition, thus creating an “expanded” or “foamed” sheet and/or profile, and article made therefrom. In any embodiment the sheets and/or articles described herein are the reaction product of a foaming agent within the polymer making up the sheets, profiles and/or articles made therefrom. This reaction product may be formed into any number of suitable foamed articles such as cups, plates, other food containing items, and food storage boxes, toys, handle grips, automotive components, and other articles of manufacture as described herein.

In any case, the hyperbranched polypropylenes described herein have several identifiable features. In any embodiment, the hyperbranched polypropylenes have an Mz_{MALLS}/Mw_{MALLS} value of greater than 3.0, or 3.2, or 3.6, or within a range from 3.0, or 3.2, or 3.6 to 5.0, or 6.0, or 8.0, or 12, or 16. Also in any embodiment, the hyperbranched polypropylenes have an MWD (Mw_{MALLS}/Mn_{DRI}) within the range from 10, or 12 to 16, or 20. Also in any embodiment, the hyperbranched polypropylenes have a branching index (g′) of less than 0.97, or 0.95, or 0.90, or within a range from 0.70, or 0.80 to 0.90, or 0.95, or 0.97, indicative of some branching and/or cross-linking of the hyperbranched polypropylene.

The hyperbranched polypropylenes have improved melt strength and extensional viscosity when compared to the high melt strength polypropylenes. In any embodiment the hyperbranched polypropylenes compositions have a Melt Strength within the range from 60 cN to 80, or 85, or 90, or 100, or 140, or 160 cN. In any embodiment, the hyperbranched polypropylenes have a Draw Ratio of greater than 4, or 5, or 6, or within a range from 4, or 5, or 5.5 to 8, or 10, or 12. In any embodiment, the hyperbranched polypropylenes have a Peak Extensional Viscosity (annealed) of greater than 500, or 800, or 1000, or 1500, or 2000, or 2200, or 2400, or 2800, or 3000 kPa·s at a strain rate of 0.01 sec⁻¹ (190° C.), or within a range of from 1000, or 1500, or 2000 kPa·s to 5000, or 5500, or 6000, or 6500, or 7000, or 8000 kPa·s. The “Peak Extensional Viscosity” or “PEV” is the difference between the highest value for the extensional viscosity.

As further evidence of any long chain branching in the hyperbranched polypropylenes, the melt flow properties were measured. Thus, in any embodiment the hyperbranched polypropylenes have an I₂₁/I₂ value of greater than 150, or 160, or 170, or within a range from 160, or 170 to 190, or 200, or 220, or 240, or 260. The I₂ value of the hyperbranched polypropylenes in any embodiment is within a range from 0.1, or 0.2, or 0.5 g/10 min to 4, or 5, or 8, or 10 g/10 min.

The crystallization and melting point temperatures of high melt strength polypropylenes, and the hyperbranched polypropylenes described below, were determined by Differential Scanning calorimetry at 10° C./min Polymer molecular weight (weight-average molecular weight, Mw, number-average molecular weight, Mn, and z-averaged molecular weight, Mz) and molecular weight distribution (Mw/Mn) are determined using Size-Exclusion Chromatography. Equipment consists of a High Temperature Size Exclusion Chromatograph (either from Waters Corporation or Polymer Laboratories), with a differential refractive index detector (DRI), an online light scattering detector, and a viscometer (SEC-DRI-LS-VIS). For purposes of the claims, SEC-DRI-LS-VIS shall be used. Three Polymer Laboratories PLgel 10 mm Mixed-B columns are used. The nominal flow rate is 0.5 cm³/min and the nominal injection volume is 300 μL. The various transfer lines, columns and differential refractometer (the DRI detector) are contained in an oven maintained at 135° C. Solvent for the SEC experiment is prepared by dissolving 6 grams of butylated hydroxy toluene as an antioxidant in 4 liters of reagent grade 1,2,4-trichlorobenzene (TCB). The TCB mixture is then filtered through a 0.7 μm glass pre-filter and subsequently through a 0.1 μm Teflon filter. The TCB is then degassed with an online degasser before entering the SEC. MALLS (Multi Angle Light Scattering) analysis is relied upon for Mw and Mz (called “Mw_{MALLS}” and “Mz_{MALLS}”) when calculating, for example, Mw_{MALLS}/Mn_{MALLS}, or Mz_{MALLS}/Mn_{MALLS}, which is the preferred method for measuring highly branched polymers, while DRI values are used for Mn, which is more sensitive and detects smaller molecules.

A MCR501 Dynamic Stress/Strain Rheometer was used to measure sheer thinning of the high melt strength polypropylenes and hyperbranched polypropylenes. A TA Instruments ARES-G2 mechanical spectrometer was used to measure strain hardening of the polypropylene samples. The samples were annealed by heated to around 200° C. for 3 min to melt the PP pellets without pressure. Then 1500 psi pressure was applied while the sample was kept heated for another 3 min between two plates. Afterwards, the pressure applied to the sample was removed while the sample was kept heated at 200° C. for another 20 min After 20 min, the sample was cooled down with water circulation without any pressure applied for additional 20 min In the experiments described herein, all samples were annealed.

The temperature can vary from 120° C. to 190° C. for extensional rheology but was set 190° C. for PP testing of both extentional viscosity and melt strength. The Hencky strain rates were 0.01 s⁻¹, 0.1 s⁻¹ and 1.0 s ⁻¹.

The method used to measure the melt strength and elongational viscosity using the Rheotester 1000 capillary rheometer in combination with the Rheotens 71.97 (Göttfert) is described in established test method RHEO4-3.3 (“Measurement of the elongational viscosity of molten polymers”).

A. Test Conditions.

The conditions for testing melt strength/extensional viscosity using the Rheotens 71-97 in combination with the Rheotester 1000 are described in RHEO4-3.3:

Rheotester 1000:
Temperature: 190° C.
Die: 30/2
Piston speed: 0.278 mm/s
Shear rate: 40.050 sec⁻¹

Strand:
Length: 100 mm
Vo: 10 mm/s

Rheotens:
Gap: 0.7 mm
Wheels: grooved
Acceleration: 12.0 mm/s²

B. Testing.

For each sample, several measurements were performed. The complete amount of sample material present in the barrel of the Rheotester was extruded through the die and was being picked up by the rolls of the Rheotens. Once the strand was placed between the rolls, the roll speed was adjusted until a force of “zero” was measured. This beginning speed “Vs” was the speed of the strand through the nip of the wheels at the start of the test. Once the test was started, the speed of the rolls was increased with a 12.0 mm/s² acceleration and the force was measured for each given speed. After each strand break, or strand slip between the rotors, the measurement was stopped and the sample material was placed back between the rolls for a new measurement. A new curve was recorded. Measuring continued until all sample material in the barrel was used.

C. Data Treatment.

After testing, all the obtained data was saved. Data which exhibited curves which were out of line were not used. The remaining curves, were cut at the same point at break or slip (maximum force measured), and were used for the calculation of a mean curve. The numerical data for the calculated mean curves is reported.

In any embodiment, the high melt strength polypropylene or hyperbranched polypropylene is an impact copolymer. An “impact copolymer” (ICP) is an intimate blend of the a polyolefin such as polypropylene with at least one elastomer such made by either in situ polymerization or ex situ physical blending. In any embodiment, such a blend is heterogeneous and forms a continuous phase comprising the polypropylene and discontinuous phase of the at least one elastomer, where most preferably the polypropylene is a high melt strength polypropylene or hyperbranched polypropylene. As used herein, an “elastomer” are those polymers or polymeric compositions that, upon application of a stretching force, are stretchable in at least one direction (e.g., the CD, MD or therebetween), and which upon release of the stretching force, contracts/returns to approximately its original dimension. For example, a stretched material may have a stretched length that is at least 50% or 80% greater than its relaxed unstretched length, and which will recover to within at least 50% of its stretched length upon release of the stretching force. In any case, the elastomer component, which can be one or a combination of two or more different “elastomers” comprises within the range from 0.5, or 1.0, or 5.0, or 10 wt % to 20, or 30, or 40, or 50 wt %, by weight of the ICP, of the ICPs described herein. In certain embodiments, the ICP consists essentially of one or more elastomers, and consist essentially of one elastomer in a most preferred embodiment.

The elastomer used to form the ICP can comprise any suitable elastomer capable of being melt blended. In any embodiment, the elastomer is selected from the group consisting of propylene-a-olefin elastomers, ethylene-a-olefin random and block copolymers (e.g., Infuse™ elastomers), natural rubber (“NR”), synthetic polyisoprene (“IR”), butyl rubber (copolymer of isobutylene and isoprene, “IIR”), halogenated butyl rubbers (chloro-butyl rubber: “CIIR”; bromo-butyl rubber: “BIIR”), polybutadiene (“BR”); styrenic copolymers and terpolymers such as styrene-butadiene rubber (“SBR” or “SBS”), styrene-isoprene-styrene (“SIS”), styrene-ethylene-propylene-styrene (“SEPS”), styrene-isobutylene-styrene, etc.; nitrile rubber, hydrogenated nitrile rubbers, chloroprene rubber (“CR”), polychloroprene, neoprene, ethylene-propylene rubber (“EPM”), ethylene-propylene-diene rubber (“EPDM”), epichlorohydrin rubber (“ECO”), polyacrylic rubber (e.g., “ACM”, “ABR”), silicone rubber, fluorosilicone rubber, fluoroelastomers, perfluoroelastomers, polyether block amides (“PEBA”), chlorosulfonated polyethylene (“CSM”), ethylene-vinyl acetate (“EVA”), and polysulfide rubber; and blends referred to as thermoplastic elastomers (“TPE”), thermoplastic vulcanizates (“TPV”), thermoplastic polyurethane (“TPU”), thermoplastic polyolefins (“TPO”) (random and block), or blends of any two or more of these specialty elastomer blends. These materials, individually or blended, can be at any molecular weight that will facilitate formation of a suitable ICP.

Styrenic Block Copolymers (“SBCs”) are a category of thermoplastic elastomers and can be used as the one or more elastomers of the ICP. Being thermoplastic elastomers, SBCs possess the mechanical properties of rubbers, and the processing characteristics of thermoplastic. This is related to their molecular structure. SBCs consist of at least three blocks, namely two hard polystyrene end blocks and one soft, elastomeric (polybutadiene, polyisoprene, hydrogenated or not) midblock. It is essential that the hard and soft blocks are immiscible, so that, on a microscopic scale, the polystyrene blocks form separate domains in the rubber matrix, thereby providing physical cross links to the rubber. Upon raising the temperature above the Tg (±100° C.) of polystyrene or on bringing the material into a hydrocarbon solvent, the polystyrene domains disintegrate and the SBCs become processable as a thermoplastic. When solidified, SBCs exhibit good elastomeric qualities. Tensile strength is higher than for unreinforced vulcanized rubbers. Elongation at Break ranges from 500% to 1200% and resilience is comparable to that of vulcanized rubbers. Melt viscosity is comparable to that of thermoplastics, such as polystyrene and polypropylene.

### Articles Comprising the Multi-Layered Sheets

In any embodiment the invention includes thermoformed articles comprising the multi-layered sheet or profile that include at least one layer of a high melt strength polypropylene or hyperbranched polypropylene. Thermoforming is a fabrication process which involves heating a sheet(s) of material such as a polyolefin and forming it over a male or female mold. The two basic types of thermoforming processes—vacuum forming and pressure forming, and derivative processes such as twin sheet thermoforming—make plastic thermoforming a broad and diverse plastic forming process. Thermoformed plastics are suited for automotive, consumer products, packaging, retail and display, sports and leisure, electronics, and industrial applications. The most advantageous aspects of thermoforming are its low tooling and engineering costs and fast turnaround time which makes thermoforming or vacuuforming ideal for prototype development and low-volume production. Non-limiting examples of thermoformed articles comprising the multi-layered sheets include pallets, tubs, dunnage, food containers (especially frozen food containers), other durable goods.

In any embodiment the invention includes blow molded articles comprising the multi-layered sheet that include at least one layer of a high melt strength polypropylene hyperbranched polypropylene. Blow molding is a molding process in which air pressure is used to inflate soft plastic into a mold cavity. It is a useful process for making one-piece hollow plastic parts with thin walls, such as bottles and similar containers. Since many of these items are used for consumer beverages for mass markets, production is typically organized for very high quantities. The technology is borrowed from the glass industry with which plastics compete in the disposable or recyclable bottle market. Blow molding is accomplished in at least two steps: (1) fabrication of a starting tube of molten material, called a parison; and (2) inflation of the tube to the desired final shape. Forming the parison is accomplished by either of two processes: extrusion or injection molding.

Extrusion blow molding typically consists of a cycle of 4 to 6 steps. In most cases, the process is organized as a very high production operation for making plastic bottles. The sequence is automated and usually integrated with downstream operations such as bottle filling and labeling. It is preferred that the blown container be rigid, and rigidity depends on wall thickness and the nature of the materials being used. The steps in extrusion blow molding can include: (1) extrusion of parison; (2) parison is pinched at the top and sealed at the bottom around a metal blow pin as the two halves of the mold come together; (3) the tube is inflated so that it takes the shape of the mold cavity; and (4) mold is opened to remove the solidified part.

In injection blow molding, the starting parison is injection molded rather than extruded. A simplified sequence is outlined below. Compared to its extrusion-based competitor, the injection blow-molding process has a lower production rate. The steps of injection blow molding can include: (1) parison is injection molded around a blowing rod; (2) injection mold is opened and parison is transferred to a blow mold; (3) soft polymer is inflated to conform to a blow mold; and (4) blow mold is opened and blown product is removed. Non-limiting examples of blow molded articles comprising the multi-layered sheets include drums, bottles, hollow panels, sheds and utility structures.

In any embodiment the invention includes a profile comprising at least one layer of a high melt strength polypropylene hyperbranched polypropylene. Profile extrusion is extrusion of a shaped product that can be a variety of configurations, and can include solid forms as well as hollow forms. Products ranging from tubing to window frames to vehicle door seals are manufactured this way and considered profile extrusion. To process hollow profiled shapes, a pin or mandrel is utilized inside the die to form the hollow section or sections. Multiple hollow sections require multiple pins. To create these hollow sections a source of positive air pressure is required to allow the center of the product to maintain shape and not collapse in a vacuum. When two or more materials are required to make a product, the co-extrusion process is preferably used. For example, a white drinking straw that has two colors of stripes, requires a total of three extruders. Each extruder feeds a different material or variation of the same material into a central co-extrusion die. Non-limiting examples of articles made from (comprising, or consisting of) a profile comprising the at least one layer of high melt strength polypropylene includes pipes, structural frames, siding, tubing, decking, window and door frames (fenestration).

The various descriptive elements and numerical ranges disclosed herein for the inventive multi-layered structures and methods of forming such can be combined with other descriptive elements and numerical ranges to describe the invention(s); further, for a given element, any upper numerical limit can be combined with any lower numerical limit described herein, including the examples in jurisdictions that allow such combinations. The features of the inventions are demonstrated in the following non-limiting examples.

### EXAMPLES

The HMS PP was a homopolymer produced using a Ziegler-Natta catalyst (Avant™ ZN168 from LyondellBasell) employing external donors as in U.S. Pat. No. 6,087,459, and having an I₂ of 3.1 g/10 min, an I₂₁ of 352 g/10 min, a Mz/Mw (DRI) of 2.9, and a melt strength of 22.2 cN. Also, the starting HMS PP used in the examples had a Mw_{DRI}/Mn_{DRI} (MWD, by DRI) of 8.4, an Mn_{DRI} value of 41,300 g/mol, an Mw_{DRI} value of 347,400 g/mole, and an Mz_{DRI} value of 1,100,000 g/mole. In the studies, the following additives were present in the HMS PP: 2000 ppm of Irganox™ 1010, 2000 ppm of Irgafos™ 168, and 500 ppm of calcium stearate.

Coextruded sheets for thermoformed parts were made using one or two layers of HDPE (I₂₁ of 10 g/10 min and a density of 0.950 g/cm³) and 150 mil (3810 μm, 3.81 mm) average thickness HMS PP, with or without regrind and compatibilizers. The sheet was then heated in an oven (260 to 538° C.) and vacuum or pressure formed into a mold to form the final article. In the examples shown in Table 1, three layer sheets (A/B/A) were produced with two different structures:

1. HDPE/HMS PP/HDPE 2. HMS PP/HDPE/HMS PP 3. HDPE 4. HMS PP

Conventional thermoforming equipment was used to make thermoformed pallets. The sheets were thermoformed into 40 inch×48 inch pallets and tested for strength using a compression test, the results of which are in Table 1. The compression test consists of loading the finished pallet with 50 pound bags until the pallet fails by collapsing under the weight. The weights reported in the table are the weights needed to collapse the pallet under load or “compression”.

The load bearing performance is as in Table 1 as well, using a 50 pound weight to determine how much the sheet sags at 25° C. The data demonstrates that the multi-layered structures offer superior compression strength and sag resistance compared to the 100% HDPE pallet and approach the stiffness of the 100% HMS PP pallet while maintaining the processability of HDPE.

TABLE 1
Test Results

| | | |
|---|---|---|
| | Compression Test, | Sand Bag/Bowing, |
| | Peak Load | amount of bow |
| Test | (lbs force) | (inches) |

| Structures | 23° C. | 150° C. | Initial | 30 min |
|---|---|---|---|---|
| 1 | 19,859 | 17,161 | 2.063 | 3.184 |
| 2 | 21,987 | 19,538 | 1.912 | 2.548 |
| 3 | 15,128 | 10,136 | 2.072 | 3.72 |
| 4 | 24,542 | 19,150 | 1.913 | 2.368 |

Having described the various features of the inventive multi-layered sheets and profiles, disclosed here in numbered paragraphs is:
P1. A multi-layered sheet or profile comprising at least one layer of a high melt strength polypropylene and one layer of another polyolefin, the high melt strength polypropylene comprising at least 50 mol % propylene, and having a molecular weight distribution (Mw_{DRI}/Mn_{DRI}) greater than 6, a branching index (g′) of at least 0.97, and a melt strength greater than 20 cN determined using an extensional rheometer at 190° C.
P2. The multi-layered sheet or profile of numbered paragraph 1, wherein the high melt strength polypropylene has an MWD (Mw_{DRI}/Mn_{DRI}) within the range from 6 to 18.
P3. The multi-layered sheet or profile of numbered paragraphs 1 or 2, wherein the high melt strength polypropylene has a Melt Strength within the range from 20 cN to 100 cN.
P4. The multi-layered sheet or profile of any one of the previous numbered paragraphs, wherein the high melt strength polypropylene has a Peak Extensional Viscosity (annealed) within a range from 15 kPa·s to 100 kPa·s at a strain rate of 0.01 sec⁻¹ (190° C.).
P5. The multi-layered sheet or profile of any one of the previous numbered paragraphs, wherein the high melt strength polypropylene comprises at least 90 mol % propylene.
P6. The multi-layered sheet or profile of any one of the previous numbered paragraphs, wherein the high melt strength polypropylene has an Mz_{DRI}/Mw_{DRI} value of less than 3.6.
P7. The multi-layered sheet or profile of any one of the previous numbered paragraphs, wherein the high melt strength polypropylene is combined with an organic peroxide to form a hyperbranched polypropylene.
P8. The multi-layered sheet or profile of any one of the previous numbered paragraphs, wherein the high melt strength polypropylene is a hyperbranched polypropylene having an Mz_{MALLS}/Mw_{MALLS} value of greater than 3.0.
P9. The multi-layered sheet or profile of any one of the previous numbered paragraphs, wherein the high melt strength polypropylene is a hyperbranched polypropylene having an MWD_{MALLS} within the range from 10 to 20.
P10. The multi-layered sheet or profile of any one of the previous numbered paragraphs, wherein the high melt strength polypropylene is a hyperbranched polypropylene having a branching index (g′) of less than 0.97.
P11. The multi-layered sheet or profile of any one of the previous numbered paragraphs, wherein the high melt strength polypropylene is a hyperbranched polypropylene having a Melt Strength within the range from 60 cN to 160 cN.
P12. The multi-layered sheet or profile of any one of the previous numbered paragraphs, wherein the high melt strength polypropylene is a hyperbranched polypropylene having a draw ratio of greater than 5.0 or 6.0 or 7.0.
P13. The multi-layered sheet or profile of any one of the previous numbered paragraphs, wherein the high melt strength polypropylene is a hyperbranched polypropylene having a Peak Extensional Viscosity (annealed) of greater than 500 or 2000 kPa·s at a strain rate of 0.01 sec⁻¹ (190° C.).
P14. The multi-layered sheet or profile of any one of the previous numbered paragraphs, wherein the high melt strength polypropylene is a hyperbranched polypropylene having an I₂₁/I₂ value of greater than 150.
P15. The multi-layered sheet or profile of claim 1, wherein the polyolefin is a polyethylene.
P16. The multi-layered sheet or profile of any one of the previous numbered paragraphs, wherein the polyethylene is a high density polyethylene having a density of at least 0.920, or 0.930 g/cm³, or within a range from 0.920 or 0.930 g/cm³ to 0.950 or 0.960 cm³.
P17. The multi-layered sheet or profile of numbered paragraph 16, wherein the polyethylene has a melt index (I₂₁, ASTM D1238 21.6 kg/190° C.) of less than 20 g/10 min; or within a range from 2.0 or 4.0 or 6.0 g/10 min to 15 or 20 g/10 min
P18. The multi-layered sheet or profile of any one of numbered paragraphs 16-17, comprising at least two layers of a high density polyethylene to form a HDPE/HMS PP/HDPE structure.
P19. The multi-layered sheet or profile of any one of numbered paragraphs 16-17, comprising two layers of high melt strength polypropylene to form a HMS PP/HDPE/HMS PP structure.
P20. The multi-layered sheet or profile of any one of the previous numbered paragraphs, wherein the polypropylene is an impact copolymer.
P21. The multi-layered sheet or profile of any one of the previous numbered paragraphs, wherein the high melt strength polypropylene is a reactor-grade material; wherein the high melt strength polypropylene has not been chemically or radiatively cross-linked and/or long-chain branched.
P22. A thermoformed article comprising the multi-layered sheet of any one of the previous numbered paragraphs.
P23. A blow molded article comprising the multi-layered sheet of any one of the previous numbered paragraphs.
P24. An article comprising a multi-layered profile according to any one of the previous numbered paragraphs.

Also disclosed is the use of a multi-layered sheet or profile comprising at least one layer of a high melt strength polypropylene and one layer of another polyolefin, the high melt strength polypropylene comprising at least 50 mol % propylene, and having a molecular weight distribution (Mw_{DRI}/Mn_{DRI}) greater than 6, a branching index (g′) of at least 0.97, and a melt strength greater than 20 cN determined using an extensional rheometer at 190° C. in an article.

For all jurisdictions in which the doctrine of “incorporation by reference” applies, all of the test methods, patent publications, patents and reference articles are hereby incorporated by reference either in their entirety or for the relevant portion for which they are referenced.

1. A multi-layered sheet or profile comprising at least one layer of a high melt strength polypropylene and one layer of another polyolefin, the high melt strength polypropylene comprising at least 50 mol % propylene, and having a molecular weight distribution (Mw_{DRI}/Mn_{DRI}) greater than 6, a branching index (g′) of at least 0.97, and a melt strength greater than 20 cN determined using an extensional rheometer at 190° C.

2. The multi-layered sheet or profile of claim 1, wherein the high melt strength polypropylene has an MWD (Mw_{DRI}/Mn_{DRI}) within the range from 6 to 18.

3. The multi-layered sheet or profile of claim 1, wherein the high melt strength polypropylene has a Melt Strength within the range from 20 cN to 100 cN.

4. The multi-layered sheet or profile of claim 1, wherein the high melt strength polypropylene has a Peak Extensional Viscosity (annealed) within a range from 15 kPa·s to 100 kPa·s at a strain rate of 0.01 sec⁻¹ (190° C.).

5. The multi-layered sheet or profile of claim 1, wherein the high melt strength polypropylene comprises at least 90 mol % propylene.

6. The multi-layered sheet or profile of claim 1, wherein the high melt strength polypropylene has an Mz_{DRI}/Mw_{DRI} value of less than 3.6.

7. The multi-layered sheet or profile of claim 1, wherein the high melt strength polypropylene is a reactor-grade material.

8. The multi-layered sheet or profile of claim 1, wherein the high melt strength polypropylene is a hyperbranched polypropylene having an Mz_{MALLS}/Mw_{MALLS} value of greater than 3.0.

9. The multi-layered sheet or profile of claim 1, wherein the high melt strength polypropylene is a hyperbranched polypropylene having an MWD_{MALLS} within the range from 10 to 20.

10. The multi-layered sheet or profile of claim 1, wherein the high melt strength polypropylene is a hyperbranched polypropylene having a branching index (g′) of less than 0.97.

11. The multi-layered sheet or profile of claim 1, wherein the high melt strength polypropylene is a hyperbranched polypropylene having a melt strength within the range from 60 cN to 160 cN.

12. The multi-layered sheet or profile of claim 1, wherein the high melt strength polypropylene is a hyperbranched polypropylene having a draw ratio of greater than 5.0.

13. The multi-layered sheet or profile of claim 1, wherein the high melt strength polypropylene is a hyperbranched polypropylene having a Peak Extensional Viscosity (annealed) of greater than 500 or 2000 kPa·s at a strain rate of 0.01 sec⁻¹ (190° C.).

14. The multi-layered sheet or profile of claim 1, wherein the high melt strength polypropylene is a hyperbranched polypropylene having an I₂₁/I₂ value of greater than 150.

15. The multi-layered sheet or profile of claim 1, wherein the polyolefin is a polyethylene.

16. The multi-layered sheet or profile of claim 1, wherein the polyethylene is a high density polyethylene having a density of at least 0.920 g/cm³.

17. The multi-layered sheet or profile of claim 16, wherein the polyethylene has a high load melt index (I₂₁, ASTM D1238 21.6 kg/190° C.) of less than 20 g/10 min.

18. The multi-layered sheet or profile of claim 16, comprising at least two layers of a high density polyethylene to form a HDPE/HMS PP/HDPE structure.

19. The multi-layered sheet or profile of claim 16, comprising two layers of high melt strength polypropylene to form a HMS PP/HDPE/HMS PP structure.

20. The multi-layered sheet or profile of claim 1, wherein the polypropylene is an impact copolymer.

21. The multi-layered sheet or profile of claim 1, wherein the high melt strength polypropylene has not been chemically or radiatively cross-linked and/or long-chain branched.

22. The multi-layered sheet or profile of claim 1, having an average thickness within a range from greater than 1.0 mm to 100 mm.

23. A thermoformed article comprising the multi-layered sheet of claim 1.

24. A blow molded article comprising the multi-layered sheet of claim 1.

25. An article comprising a multi-layered profile according to claim 1.
